(19) United States
(12) Patent Application Publication
(10) Pub. No.: US 2019/0184994 A1
(43) Pub. Date: Jun. 20, 2019

(54) TRAVEL CONTROL APPARATUS OF SELF-DRIVING VEHICLE

(71) Applicant: Honda Motor Co., Ltd., Tokyo (JP)

(72) Inventors: Toshiyuki Mizuno, Wako-shi (JP); Akira Kito, Wako-shi (JP); Takayuki Kishi, Wako-shi (JP); Yoshiaki Konishi, Wako-shi (JP)

(21) Appl. No.: 16/216,906

(22) Filed: Dec. 11, 2018

(30) Foreign Application Priority Data
Dec. 18, 2017 (JP) 2017-242111

(51) Int. Cl. B60W 30/165; B60W 30/18; G08G 1/015; G06K 9/00

(52) U.S. Cl. CPC B60W 30/165; B60W 30/18163; B60W 2550/302; G06K 9/00825; G08G 1/015

(57) ABSTRACT

A travel control apparatus of a self-driving vehicle with a driving part for traveling including a vehicle detector detecting another vehicle around the self-driving vehicle and an electric control unit having a microprocessor and a memory. The microprocessor is configured to perform generating an action plan so as to follow the other vehicle detected by the vehicle detector as a target vehicle, and controlling the driving part in accordance with the action plan generated in the generating, in which the generating includes recognizing a size class of the other vehicle; determining whether the other vehicle satisfies a condition that a degree of difference of the recognized size class from a size class of the self-driving vehicle is equal to or less than a predetermined degree; and designating the other vehicle determined to satisfy the condition as the target vehicle.

### CROSS-REFERENCE TO RELATED APPLICATION

This application is based upon and claims the benefit of priority from Japanese Patent Application No. 2017-242111 filed on Dec. 18, 2017, the content of which is incorporated herein by reference.

### BACKGROUND OF THE INVENTION

### Field of the Invention

This invention relates to a travel control apparatus of a self-driving vehicle.

### Description of the Related Art

Conventionally, there is a known apparatus of this type, configured to control a self-driving vehicle so as to follow a forward vehicle with an inter-vehicle distance from the self-driving vehicle to the forward vehicle maintained to a predetermined inter-vehicle distance. Such an apparatus is described in Japanese Unexamined Patent Publication No. 2017-092678 (JP2017-092678A), for example.

However, when the self-driving vehicle follows the forward vehicle of a different vehicle size class from the self-driving vehicle, it is sometimes difficult for the self-driving vehicle to avoid obstacles avoided easily by the forward vehicle, for example. As a result, the following travel may cause trouble.

### SUMMARY OF THE INVENTION

An aspect of the present invention is a travel control apparatus of a self-driving vehicle with a driving part for traveling includes a vehicle detector configured to detect another vehicle around the self-driving vehicle, and an electric control unit having a microprocessor and a memory. The microprocessor is configured to perform generating an action plan so as to follow the other vehicle detected by the vehicle detector as a target vehicle, and controlling the driving part in accordance with the action plan generated in the generating so as to follow the target vehicle. The microprocessor is configured to perform the generating including: recognizing a size class of the other vehicle detected by the vehicle detector; determining whether the other vehicle satisfies a condition that a degree of a difference of the size class of the other vehicle recognized in the recognizing from a size class of the self-driving vehicle is equal to or less than a predetermined degree; and designating the other vehicle determined to satisfy the condition in the determining as the target vehicle.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle incorporating a travel control apparatus according to an embodiment of the present invention;

FIG. 2 is a block diagram schematically illustrating overall configuration of a vehicle control system of the self-driving vehicle to which a travel control apparatus according to an embodiment of the present invention is applied;

FIG. 3 is a diagram showing an example of an action plan generated by an action plan generation unit of FIG. 2;

FIG. 4 is a diagram showing an example of a shift map stored in a memory unit of FIG. 2;

FIG. 5 is a block diagram illustrating main configuration of the travel control apparatus of the self-driving vehicle according to the embodiment of the present invention;

FIG. 6 is a flow chart showing an example of processing performed by a processing unit of FIG. 5;

FIG. 7A is a diagram showing an example of operation by the travel control apparatus of the self-driving vehicle according to the embodiment of the present invention;

FIG. 7B is a diagram showing an example of operation following FIG. 7A;

FIG. 7C is a diagram showing an example of operation following FIG. 7B;

FIG. 8A is a diagram showing another example of operation by the travel control apparatus of the self-driving vehicle according to the embodiment of the present invention;

FIG. 8B is a diagram showing an example of operation following FIG. 8A;

FIG. 8C is a diagram showing an example of operation following FIG. 8B;

FIG. 9A is a time chart showing an example of change of speed stage and vehicle speed corresponding to operations of FIG. 7A to FIG. 7C; and

FIG. 9B is a time chart showing an example of change of speed stage and vehicle speed corresponding to operations of FIG. 8A to FIG. 8C.

### DETAILED DESCRIPTION OF THE INVENTION

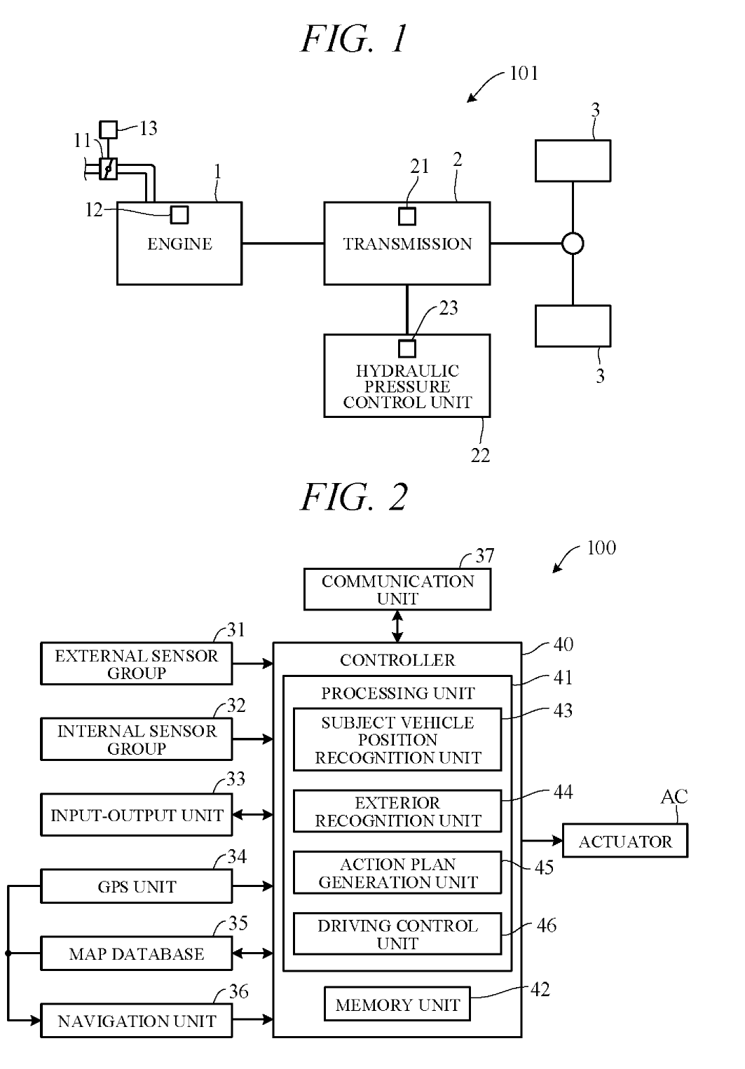

Hereinafter, an embodiment of the present invention is explained with reference to FIGS. 1 to 9B. A travel control apparatus according to an embodiment of the present invention is applied to a vehicle (self-driving vehicle) having a self-driving capability. FIG. 1 is a diagram showing a configuration overview of a driving system of a self-driving vehicle 101 incorporating a travel control apparatus according to the present embodiment. Herein, the self-driving vehicle may be sometimes called “subject vehicle” to differentiate it from other vehicles. The vehicle 101 is not limited to driving in a self-drive mode requiring no driver driving operations but is also capable of driving in a manual drive mode by driver operations.

As shown in FIG. 1, the vehicle 101 includes an engine 1 and a transmission 2. The engine 1 is an internal combustion engine (e.g., gasoline engine) wherein intake air supplied through a throttle valve and fuel injected from an injector are mixed at an appropriate ratio and thereafter ignited by a sparkplug or the like to burn explosively and thereby generate rotational power. A diesel engine or any of various other types of engine can be used instead of a gasoline engine. Air intake volume is metered by the throttle valve. An opening angle of the throttle valve 11 (throttle opening angle) is changed by a throttle actuator 13 operated by an electric signal. The opening angle of the throttle valve 11 and an amount of fuel injected from the injector 12 (injection timing and injection time) are controlled by a controller 40 (FIG. 2).

The transmission 2, which is installed in a power transmission path between the engine 1 and drive wheels 3, varies speed ratio of rotation of from the engine 1, and converts and outputs torque from the engine 1. The rotation of speed converted by the transmission 2 is transmitted to the drive wheels 3, thereby propelling the vehicle 101. Optionally, the vehicle 101 can be configured as an electric vehicle or hybrid vehicle by providing a drive motor as a drive power source in place of or in addition to the engine 1.

The transmission 2 is, for example, a stepped transmission enabling stepwise speed ratio (gear ratio) shifting in accordance with multiple (e.g. eight) speed stages. Optionally, a continuously variable transmission enabling stepless speed ratio shifting can be used as the transmission 2. Although omitted in the drawings, power from the engine 1 can be input to the transmission 2 through a torque converter. The transmission 2 can, for example, incorporate a dog clutch, friction clutch or other engaging element 21. A hydraulic pressure control unit 22 can shift speed stage of the transmission 2 by controlling flow of oil to the engaging element 21. The hydraulic pressure control unit 22 includes a solenoid valve or other valve mechanism operated by electric signals (called “shift actuator 23” for sake of convenience), and an appropriate speed stage can be implemented by changing flow of hydraulic pressure to the engaging element 21 in response to operation of the shift actuator 23.

FIG. 2 is a block diagram schematically illustrating overall configuration of a vehicle control system 100 of the self-driving vehicle 101 to which a travel control apparatus according to an embodiment of the present invention is applied. As shown in FIG. 2, the vehicle control system 100 includes mainly of the controller 40, and as members communicably connected with the controller 40 through CAN (Controller Area Network) communication or the like, an external sensor group 31, an internal sensor group 32, an input-output unit 33, a GPS unit 34, a map database 35, a navigation unit 36, a communication unit 37, and actuators AC.

The term external sensor group 31 herein is a collective designation encompassing multiple sensors (external sensors) for detecting external circumstances constituting subject vehicle ambience data. For example, the external sensor group 31 includes, inter alia, a LIDAR (Light Detection and Ranging) for measuring distance from the vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways). The inter-vehicle distance from the subject vehicle to other vehicles can be measured by any of LIDAR, RADAR and the on-board cameras.

The term internal sensor group 32 herein is a collective designation encompassing multiple sensors (internal sensors) for detecting subject vehicle driving state. For example, the internal sensor group 32 includes, inter alia, a vehicle speed sensor for detecting subject vehicle running speed, acceleration sensors for detecting subject vehicle forward-rearward direction acceleration and lateral acceleration, respectively, an engine speed sensor for detecting engine rotational speed, a yaw rate sensor for detecting rotation angle speed around a vertical axis through subject vehicle center of gravity, and a throttle opening sensor for detecting throttle opening angle. The internal sensor group 32 also includes sensors for detecting driver driving operations in manual drive mode, including, for example, accelerator pedal operations, brake pedal operations, steering wheel operations and the like.

The term input-output unit 33 is used herein as a collective designation encompassing apparatuses receiving instructions input by the driver and outputting information to the driver. For example, the input-output unit 33 includes, inter alia, switches which the driver uses to input various instructions, a microphone which the driver uses to input voice instructions, a display for presenting information to the driver via displayed images, and a speaker for presenting information to the driver by voice. The switches include a mode select switch for instructing either self-drive mode or manual drive mode, and a driving level instruction switch for instructing a driving automation level.

The mode select switch, for example, is configured as a switch manually operable by the driver to output instruction of switching between the self-drive mode enabling self-drive functions and the manual drive mode disabling self-drive functions in accordance with an operation of the switch. Optionally, the mode select switch can be configured to instruct switching from manual drive mode to self-drive mode or from self-drive mode to manual drive mode when a predetermined condition is satisfied without operating the mode select switch. In other words, mode select can be performed automatically not manually in response to automatic switching of the mode select switch.

The driving level instruction switch is, for example, configured as a switch manually operable by the driver to instruct the driving automation level in accordance with an operation of the switch. The driving automation level is an index of driving automation degree. SAE J3016 recommended by SAE (Society of Automotive Engineers) International, for example, classifies driving automation into Level 0 to Level 5. Level 0 indicates no driving automation. At level 0, all driving operations are performed by a human operator (driver).

At Level 1, the vehicle control system performs one among acceleration, steering and braking of the Dynamic Driving Task (DDT) (in driver assistance automation). At Level 1, therefore, the vehicle control system 100 operates under specified conditions to control some among the accelerator, brakes and steering wheel in accordance with surrounding circumstances, and the driver performs all of the remaining DDT.

At Level 2, the system simultaneously performs multiple DDT subtasks among acceleration, steering and braking (in partial driving automation). Up to Level 2, the driver is responsible for monitoring vehicle surroundings.

At Level 3, the system performs all of the DDT acceleration, steering and braking subtasks, and the driver responds only when requested by the vehicle control system 100 (conditional driving automation). At Level 3 and higher, the vehicle control system 100 monitors the surroundings and no responsibility to monitor surroundings falls on a human.

At Level 4, the vehicle control system 100 performs the entire DDT under specified conditions and a user (driver) does not take over even when the vehicle control system 100 cannot continue driving (high driving automation). At Level 4 and higher, therefore, the system deals even with emergency situations.

At Level 5, the vehicle control system 100 autonomously self-drives under all conditions (full driving automation).

The driving level instruction switch is configured to select one of Levels 0 to 5 as driving automation level in accordance with the operation thereof. Optionally, the vehicle control system 100 can be adapted to determine whether factors like surrounding circumstances satisfy conditions enabling self-driving and automatically operate the driving level instruction switch to instruct selection of one of the Levels 0 to 5 in accordance with the determination results. For example, when a predetermined condition is satisfied, the vehicle control system 100 can automatically switch driving automation level from Level 2 to Level 3.

The GPS unit 34 includes a GPS receiver for receiving position determination signals from multiple GPS satellites, and measures absolute position (latitude, longitude and the like) of the subject vehicle based on the signals received from the GPS receiver.

The map database 35 is a unit storing general map data used by the navigation unit 36 and is, for example, implemented using a hard disk. The map data include road position data and road shape (curvature etc.) data, along with intersection and road branch position data. The map data stored in the map database 35 are different from high-accuracy map data stored in a memory unit 42 of the controller 40.

The navigation unit 36 retrieves target road routes to destinations input by the driver and performs guidance along selected target routes. Destination input and target route guidance is performed through the input-output unit 33. Target routes are computed based on subject vehicle current position measured by the GPS unit 34 and map data stored in the map database 35.

The communication unit 37 communicates through networks including the Internet and other wireless communication networks to access servers (not shown in the drawings) to acquire map data, traffic data and the like, periodically or at arbitrary times. Acquired map data are output to the map database 35 and/or memory unit 42 to update their stored map data. Acquired traffic data include congestion data and traffic light data including, for instance, time to change from red light to green light.

The actuators AC are provided to perform driving of the vehicle 101. The actuators AC include a throttle actuator 13 for adjusting opening angle of the throttle valve of the engine 1 (throttle opening angle) and a shift actuator 23 for changing speed stage of the transmission 2, as shown in FIG. 1, and further a brake actuator for operating a braking device, and a steering actuator for driving a steering unit.

The controller 40 is constituted by an electronic control unit (ECU). In FIG. 2, the controller 40 is integrally configured by consolidating multiple function-differentiated ECUs such as an engine control ECU, a transmission control ECU, a clutch control ECU and so on. Optionally, these ECUs can be individually provided. The controller 40 incorporates a computer including a CPU or other processing unit (a microprocessor) 41, the memory unit (a memory) 42 of RAM, ROM, hard disk and the like, and other peripheral circuits not shown in the drawings.

The memory unit 42 stores high-accuracy detailed map data including, inter alia, lane center position data and lane boundary line data. More specifically, road data, traffic regulation data, address data, facility data, telephone number data and the like are stored as map data. The road data include data identifying roads by type such as expressway, toll road and national highway, and data on, inter alia, number of road lanes, individual lane width, road gradient, road 3D coordinate position, lane curvature, lane merge and branch point positions, and road signs. The traffic regulation data include, inter alia, data on lanes subject to traffic restriction or closure owing to construction work and the like. The memory unit 42 also stores a shift map (shift chart) serving as a shift operation reference, various programs for performing processing, threshold values used in the programs, and a size class of the self-driving vehicle, etc.

As functional configurations, the processing unit 41 includes a subject vehicle position recognition unit 43, an exterior recognition unit 44, an action plan generation unit 45, and a driving control unit 46.

The subject vehicle position recognition unit 43 recognizes map position of the subject vehicle (subject vehicle position) based on subject vehicle position data calculated by the GPS unit 34 and map data stored in the map database 35. Optionally, the subject vehicle position can be recognized using map data (building shape data and the like) stored in the memory unit 42 and ambience data of the vehicle 101 detected by the external sensor group 31, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 37.

The exterior recognition unit 44 recognizes external circumstances around the subject vehicle based on signals from cameras, LIDERs, RADARs and the like of the external sensor group 31. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road boundary and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 45 generates a subject vehicle driving path (target path) from present time point to a certain time ahead based on, for example, a target route computed by the navigation unit 36, subject vehicle position recognized by the subject vehicle position recognition unit 43, and external circumstances recognized by the exterior recognition unit 44. When multiple paths are available on the target route as target path candidates, the action plan generation unit 45 selects from among them the path that optimally satisfies legal compliance, safe efficient driving and other criteria, and defines the selected path as the target path. The action plan generation unit 45 then generates an action plan matched to the generated target path. An action plan is also called “travel plan”.

The action plan includes action plan data set for every unit time Δt (e.g., 0.1 sec) between present time point and a predetermined time period T (e.g., 5 sec) ahead, i.e., includes action plan data set in association with every unit time Δt interval. The action plan data include subject vehicle position data and vehicle state data for every unit time Δt. The position data are, for example, target point data indicating 2D coordinate position on road, and the vehicle state data are vehicle speed data indicating vehicle speed, direction data indicating subject vehicle direction, and the like. The vehicle state data can be determined from position data change of successive unit times Δt. Action plan is updated every unit time Δt.

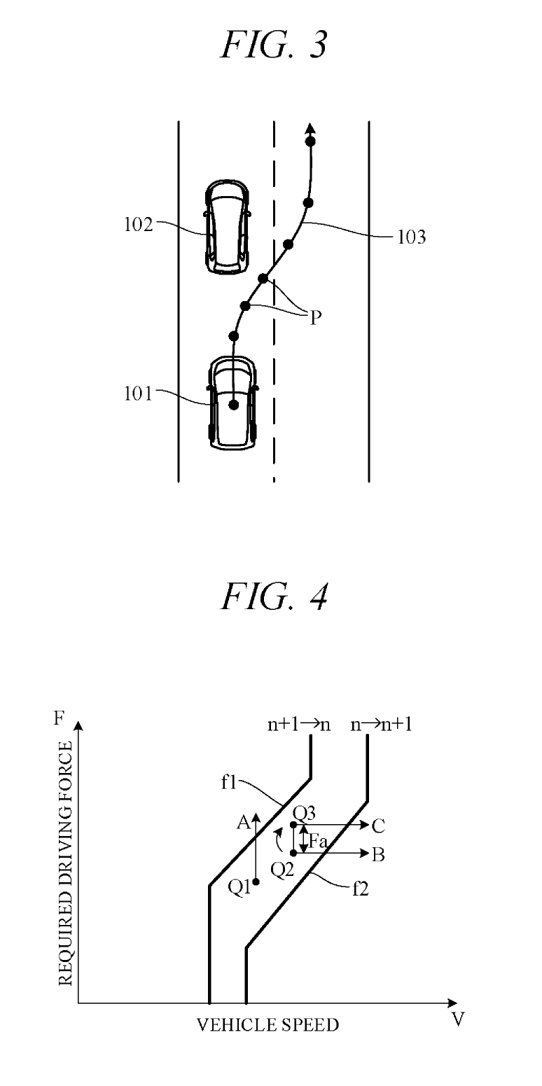

FIG. 3 is a diagram showing an action plan generated by the action plan generation unit 45. FIG. 3 shows a scene depicting an action plan for the subject vehicle 101 when changing lanes and overtaking a vehicle 102 ahead. Points P in FIG. 3 correspond to position data at every unit time Δt between present time point and predetermined time period T1 ahead. A target path 103 is obtained by connecting the points P in time order. The action plan generation unit 45 generates not only overtake action plans but also various other kinds of action plans for, inter alia, lane-changing to move from one traffic lane to another, lane-keeping to maintain same lane and not stray into another, and decelerating or accelerating.

When generating a target path, the action plan generation unit 45 first decides a drive mode and generates the target path in line with the drive mode. When creating an action plan for lane-keeping, for example, the action plan generation unit 45 firsts decides drive mode from among modes such as cruising, overtaking, decelerating, and curve negotiating. To cite particular cases, the action plan generation unit 45 decides cruising mode as drive mode when no other vehicle is present ahead of the subject vehicle (no forward vehicle) and decides following mode as drive mode when a vehicle ahead is present. In following mode, the action plan generation unit 45 generates, for example, travel plan data for suitably controlling inter-vehicle distance to a forward vehicle in accordance with vehicle speed. Target inter-vehicle distances in accordance with vehicle speed are stored in memory unit 42 in advance.

In self-drive mode, the driving control unit 46 controls the actuators AC to drive the subject vehicle 101 along target path 103 generated by the action plan generation unit 45. For example, the driving control unit 46 controls the throttle actuator 13, shift actuator 23, brake actuator and steering actuator so as to drive the subject vehicle 101 through the points P of the unit times Δt in FIG. 3.

More specifically, in self-drive mode, the driving control unit 46 calculates acceleration (target acceleration) of sequential unit times Δt based on vehicle speed (target vehicle speed) at points P of sequential unit times Δt on target path 103 (FIG. 3) included in the action plan generated by the action plan generation unit 45. In addition, the driving control unit 46 calculates required driving force for achieving the target accelerations taking running resistance caused by road gradient and the like into account. And the actuators AC are feedback controlled to bring actual acceleration detected by the internal sensor group 32, for example, into coincidence with target acceleration. On the other hand, in manual drive mode, the driving control unit 46 controls the actuators AC in accordance with driving instructions by the driver (accelerator opening angle and the like) acquired from the internal sensor group 32.

Controlling of the transmission 2 by the driving control unit 46 is explained concretely. The driving control unit 46 controls shift operation of the transmission 2 by outputting control signals to the shift actuator 23 using a shift map stored in the memory unit 42 in advance to serve as a shift operation reference.

FIG. 4 is a diagram showing an example of the shift map stored in the memory unit 42, particularly an example of the shift map in self-drive mode. In the drawing, horizontal axis is scaled for vehicle speed V and vertical axis for required driving force F. Required driving force F is in one-to-one correspondence to accelerator opening angle which is an amount of operation of an accelerator (in self-drive mode, simulated accelerator opening angle) or throttle opening angle, and required driving force F increases with increasing accelerator opening angle or throttle opening angle. Therefore, the vertical axis can instead be scaled for accelerator opening angle or throttle opening angle.

In FIG. 4, characteristic curve f1 is an example of a downshift curve corresponding to downshift from n+1 stage to n stage and characteristic curve f2 is an example of an upshift curve corresponding to upshift from n stage to n+1 stage. Although omitted in the drawings, considering downshift and upshift of other speed stages, the downshift curve and upshift curve are shifted further to high vehicle speed side in proportion as the speed stage is greater (higher).

For example, considering downshift from operating point Q1 in FIG. 4, in a case where required driving force F increases under constant vehicle speed V, the transmission 2 downshifts from n+1 stage to n stage when operating point Q1 crosses a downshift curve (characteristic curve f1; arrow A). On the other hand, considering upshift from operating point Q2, in a case where vehicle speed V increases under constant required driving force F, the transmission 2 upshifts from n stage to n+1 stage when operating point Q2 crosses an upshift curve (characteristic curve f2; arrow B).

Optionally, as regards upshift, the transmission 2 may be controlled so as to upshift from n stage to n+1 stage when operating point Q3, obtained by adding predetermined excess driving force Fa to required driving force F at operating point Q2, crosses upshift curve (characteristic curve f2; arrow C).

In other words, upshift tendency of the transmission 2 is restrained by raising apparent required driving force F by excess driving force Fa and delaying upshifting than when excess driving force Fa is 0. As a result, the self-driving vehicle can travel in a state of improving responsiveness of acceleration. Therefore, in a case that the self-driving vehicle follows the forward vehicle, after designating a target vehicle as a target of following travel, the following travel for the target vehicle can be rapidly start. When required driving force F becomes small, excess driving force Fa is reduced, and in cruising travel state, excess driving force is 0.

A point requiring consideration in this regard is that when the subject vehicle follows a preceding vehicle (forward vehicle) of a different vehicle size class from the subject vehicle, the subject vehicle may sometimes not be able to achieve easy and proper vehicle-following. For example, when the subject vehicle is a standard size car but the vehicle ahead (forward vehicle) is a large truck, minimum ground clearance of the forward vehicle (truck) is higher than that of the subject vehicle, so that the subject vehicle may sometimes not be able to pass over obstacles passed over by the forward vehicle. Or to give another example, when the subject vehicle has a wide width but the forward vehicle is a small size car or other such narrow width vehicle, the subject vehicle sometimes may not be able to pass through a narrow place easily passable by the forward vehicle. Thus, the subject vehicle may have difficulty following a preceding vehicle when its size (height, width and the like) is different from that of the forward vehicle. The travel control apparatus according to the present embodiment is configured with attention to such vehicle-following issues.

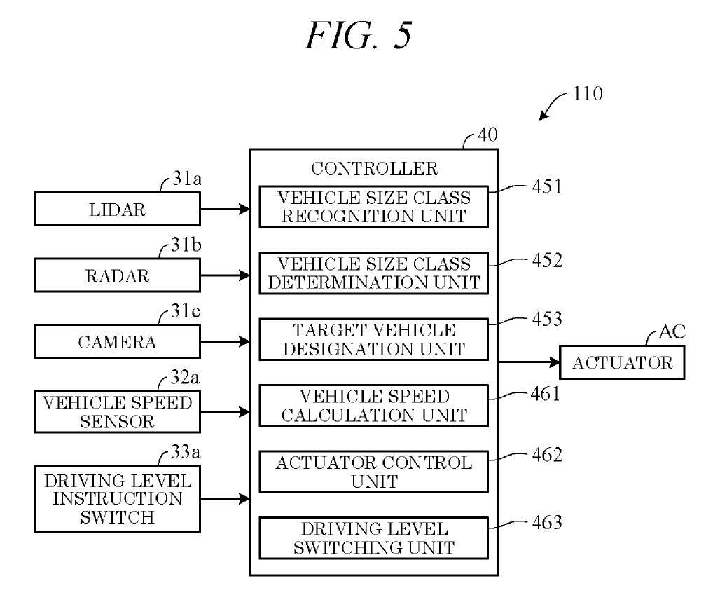

FIG. 5 is a block diagram showing main components of a travel control apparatus 110 according to an embodiment of the present invention. The travel control apparatus 110, which serves as one part of the vehicle control system 100, is primarily responsible for implementing vehicle-following under self-driving mode. Configurations in common with those of FIG. 2 are assigned like reference symbols in FIG. 5. As shown in FIG. 5, the controller 40 receives signals from a LIDAR 31a, RADAR 31b and camera 31c among members of the external sensor group 31, signals from a vehicle speed sensor 32a among members of the internal sensor group 32, and signals from a driving level instruction switch 33a among members of the input-output unit 33.

As functional configurations, the controller 40 includes a vehicle size class recognition unit 451, a vehicle size class determination unit 452, a target vehicle designation unit 453, a vehicle speed calculation unit 461, an actuator control unit 462, and a driving level switching unit 463. The vehicle size class recognition unit 451, vehicle size class determination unit 452 and target vehicle designation unit 453 are configured by, for example, the action plan generation unit 45 of FIG. 2, and the vehicle speed calculation unit 461, actuator control unit 462, and driving level switching unit 463 are configured by, for example, the driving control unit 46 of FIG. 2.

The vehicle size class recognition unit 451 uses signals from the LIDAR 31a, RADAR 31b and camera 31c to recognize other vehicles around the subject vehicle. In addition, it recognizes size class of other vehicles based on signals from the camera 31c. Vehicle size class is defined, for example, in terms of size of other vehicle as viewed from behind, i.e., vehicle width and vehicle height, and the vehicle size class recognition unit 451 recognizes other vehicle width and height based on camera images.

The vehicle size class determination unit 452 determines whether degree of difference between other vehicle size class recognized by the vehicle size class recognition unit 451 and subject vehicle size class stored in the memory unit 42 (FIG. 2) is equal to or less than a predetermined value. More specifically, it determines whether height difference and width difference between the subject vehicle and other vehicle are equal to or less than respective predetermined values. In other words, it determines whether size class of the other vehicle and size class of the subject vehicle are substantially equal (of similar size class).

The target vehicle designation unit 453 selects a followable vehicle from among other vehicles determined by the vehicle size class determination unit 452 to be of similar size class and designates that followable vehicle as target vehicle, i.e., as a vehicle targeted for vehicle-following. For example, when the target vehicle designation unit 453 determines from surrounding circumstances recognized by the exterior recognition unit 44 (FIG. 2) that the subject vehicle is able to change lanes to behind another vehicle determined to be of similar size class, it designates that vehicle as a target vehicle. In such a case, lane change is determined to be possible when, for example, adequate space for lane changing is available behind the other vehicle and speed difference between the other vehicle and the subject vehicle is small.

The vehicle speed calculation unit 461 calculates speed of the vehicle designated as the target vehicle by the target vehicle designation unit 453. Specifically, the vehicle speed calculation unit 461 uses signals from the LIDAR 31a and/or RADAR 31b to calculate inter-vehicle distance between the subject vehicle and the target vehicle, and calculates speed of the target vehicle relative to the subject vehicle by calculating time derivative of the calculated inter-vehicle distance. Speed of the target vehicle is calculated by adding this calculated relative speed to the subject vehicle speed detected by the vehicle speed sensor 32a.

The actuator control unit 462 controls the actuators AC so that the subject vehicle follows the target vehicle of similar size class designated by the target vehicle designation unit 453. Specifically, once the target vehicle designation unit 453 designates another vehicle running in an adjacent lane as a target vehicle, the actuator control unit 462 first determines whether speed of the target vehicle calculated by the vehicle speed calculation unit 461 is faster than speed of the subject vehicle.

When, as a first example, the subject vehicle while running in a first lane (e.g., slow lane) is approached from behind by a target vehicle running in an adjacent second lane (e.g., passing lane), the actuator control unit 462 determines that speed of the target vehicle is faster. In such case, the actuator control unit 462 outputs a control signal to the shift actuator 23 among the actuators AC so as to downshift the transmission 2. This forcible downshifting of the transmission 2 is for increasing acceleration response of the subject vehicle. Moreover, the actuator control unit 462 adds the excess driving force Fa to the required driving force F (FIG. 4) in order to prevent upshifting immediately after the downshift. Once the target vehicle overtakes the subject vehicle, the actuator control unit 462 outputs control signals to actuators AC for causing the subject vehicle to change to the second lane and start to follow the target vehicle. Optionally, the excess driving force Fa can be lowered after the vehicle-following starts.

When, as a second example, the subject vehicle while running in a first lane (e.g., passing lane) approaches from behind a target vehicle running in an adjacent second lane (e.g., slow lane), the actuator control unit 462 determines that speed of the target vehicle is slower. In such case, the actuator control unit 462 controls the shift actuator 23 so as to maintain or downshift the speed stage of the transmission 2. For example, when speed of subject vehicle relative to the target vehicle is equal to or less than a predetermined value, the subject vehicle does not need to be accelerated but needs to be slightly decelerated. In such case, the actuator control unit 462 outputs control signals to actuators AC while maintaining the current speed stage so as to cause the subject vehicle to change to the second lane and start to follow the target vehicle.

On the other hand, when speed of subject vehicle relative to the target vehicle is greater than the predetermined value, decelerating force of the subject vehicle needs to be increased. Therefore, in order to invoke adequate engine braking or regenerative force braking, the actuator control unit 462 outputs a control signal to the shift actuator 23 to downshift the transmission 2. This enables the subject vehicle to smoothly decelerate in line with the speed of the target vehicle. After the transmission 2 is downshifted, the actuator control unit 462 causes the subject vehicle to change lanes and move to behind the target vehicle to begin vehicle-following.

The driving level switching unit 463 switches driving level in response to instruction from the driving level instruction switch 33a. However, when a target vehicle that is not a similar size class vehicle is followed during vehicle-following in level 2, the driving level switching unit 463 prohibits switching to level 3 even when switching from level 2 to level 3 is instructed by operation of the driving level instruction switch 33a. In other words, switching of self-driving level 3 is allowed only on condition of a target vehicle of similar size class being followed.

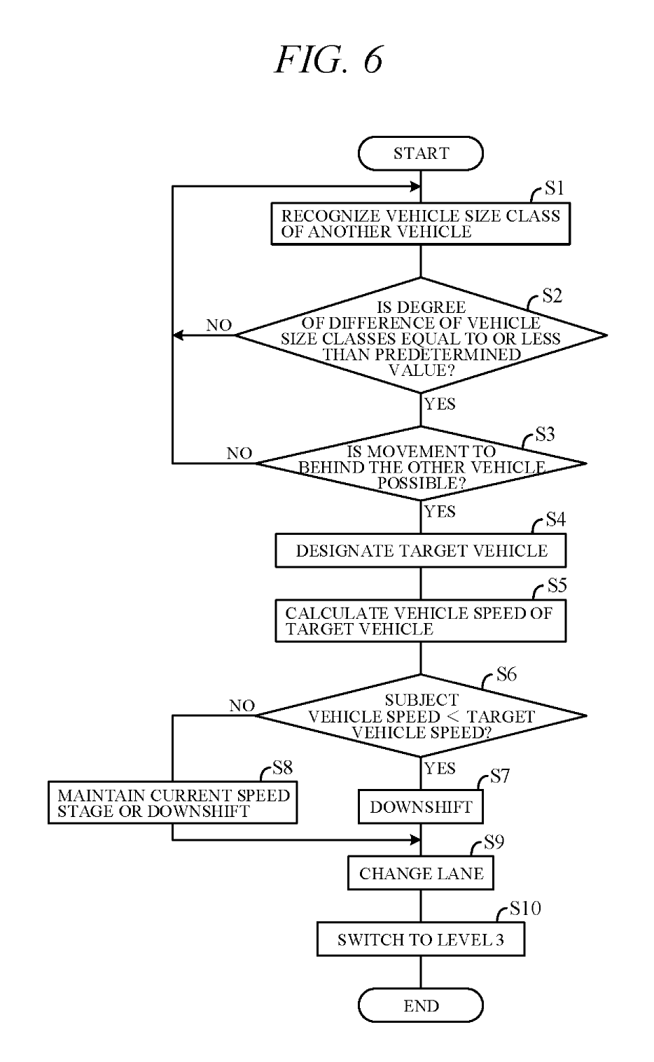

FIG. 6 is a flowchart showing an example of processing performed by the controller 40 of FIG. 5 in accordance with a predefined program. The processing of this flowchart is started when, in the course of running in self-drive mode at a driving level of, for example, lower than level 3 (e.g., level 2), switching to level 3 is instructed by operation of the driving level instruction switch 33a. In order to realize switching to level 3 in accordance with the instruction from the driving level instruction switch 33a in this case, processing is performed for effecting vehicle-following of a target vehicle of similar size class.

First, in S1 (S: processing Step), the vehicle size class recognition unit 451 uses signals from, inter alia, the camera 31c to recognize vehicle size class of another vehicle near the subject vehicle. Next, in S2, the vehicle size class determination unit 452 determines whether degree of difference between other vehicle size class recognized in S1 and subject vehicle size class stored in advance in the memory unit 42 is equal to or less than a predetermined value, more specifically, whether height difference and width difference between the subject vehicle and the other vehicle are equal to or less than respective predetermined values. When the other vehicle and the subject vehicle are of similar size class, a positive decision is made at S2 and the routine proceeds to S3. If a negative decision is made at S2, the routine proceeds to S1.

In S3, whether movement to behind the other vehicle of similar size class (lane change) is possible is determined. Movement to behind the other vehicle of similar size class is determined to be possible when, for example, adequate space is available behind the other vehicle of similar size class and speed difference between it and the subject vehicle is small. Conversely, movement to behind the other vehicle of similar size class is determined to be impossible when adequate space is not available behind the other vehicle of similar size class or speed difference between it and the subject vehicle is large. If a positive decision is made at S3, the routine proceeds to S4, and if a negative decision is made, returns to S1. In S4, the other vehicle of similar size class behind which the subject vehicle can move is designated as target vehicle by the target vehicle designation unit 453.

Next, in S5, the vehicle speed calculation unit 461 calculates vehicle speed of the target vehicle. Then in S6, whether target vehicle speed is faster than subject vehicle speed detected by the vehicle speed sensor 32a is determined. If a positive decision is made at S6, the routine proceeds to S7, in which the actuator control unit 462 outputs a control signal to the shift actuator 23 to downshift the transmission 2 in preparation for acceleration.

If a negative decision is made at S6, the routine proceeds to S8. In this case, when the speeds of the subject vehicle and the target vehicle are substantially the same, i.e., when speed difference is equal to or less than a predetermined value, the actuator control unit 462 controls the transmission 2 so as to maintain the current speed stage. However, when the speed of the subject vehicle is greater than that of the target vehicle and the speed difference between the subject vehicle and the target vehicle is greater than the predetermined value, the actuator control unit 462 downshifts the transmission 2 in order to develop greater subject vehicle decelerating force by engine braking and/or regenerative force braking.

Next, in S9, the actuator control unit 462 outputs control signals to actuators AC to make the subject vehicle change lanes and move to behind the other vehicle designated as the target vehicle, and also outputs control signals to actuators AC to adjust inter-vehicle distance between the subject vehicle and the target vehicle to desired inter-vehicle distance, whereby the subject vehicle performs vehicle-following with respect to the target vehicle. Next, in S10, self-driving level is switched to level 3 in which the driver has no forward surveillance responsibility.

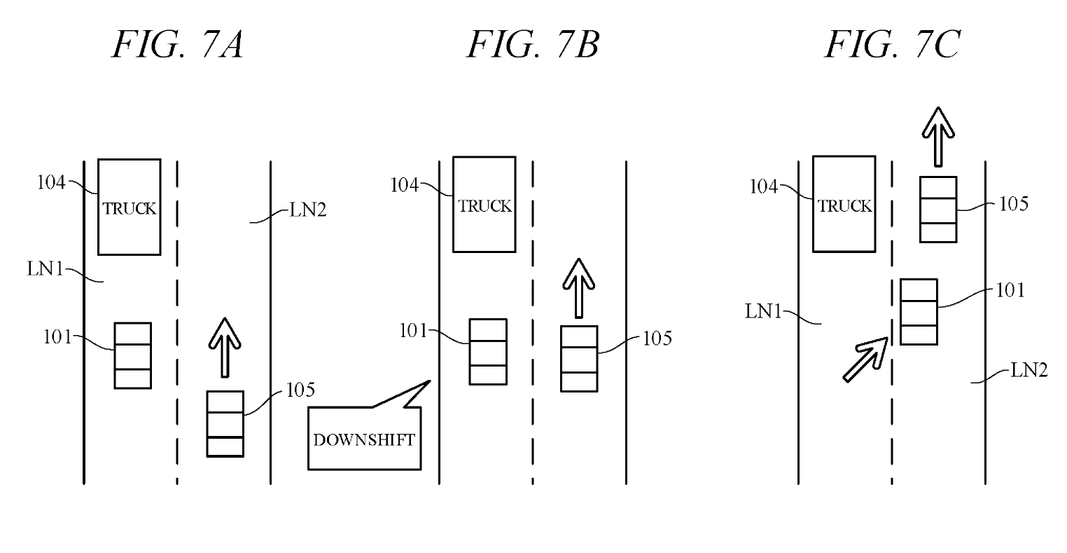

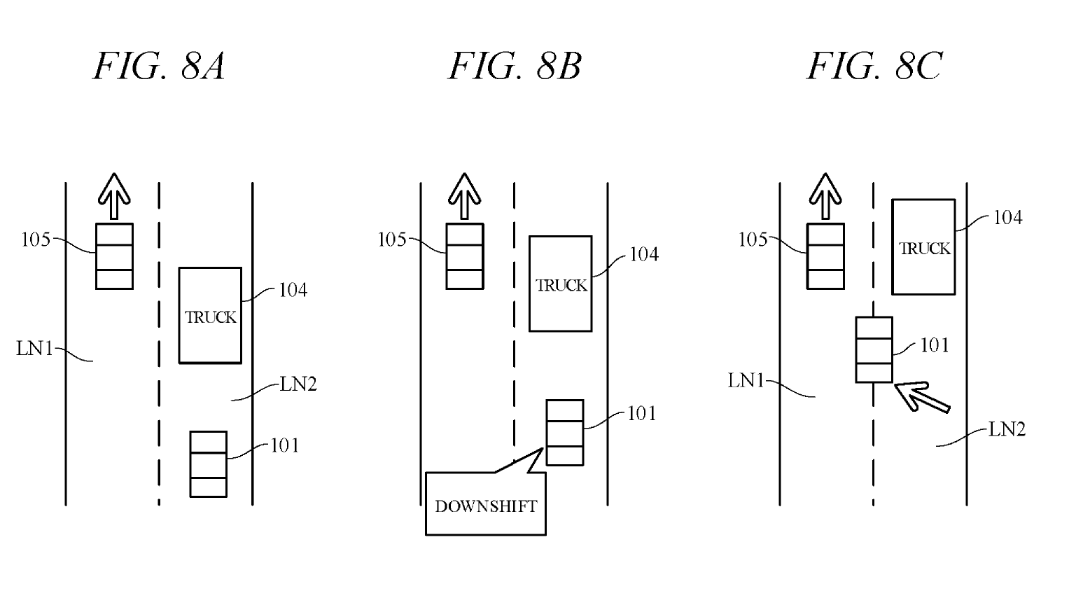

Operation of the travel control apparatus 110 according to the present embodiment is more concretely explained in the following. FIGS. 7A, 7B and 7C and FIGS. 8A, 8B and 8C are sets of drawings showing behavior in cases where, while running in self-driving level 2, the driving level instruction switch 33a instructs level 3 at a time when the subject vehicle 101 (e.g., a standard size passenger car) of a different vehicle size class from a forward vehicle (e.g., a truck) 104 on traffic lane LN1 or LN2 is in a vehicle-following state behind the forward vehicle 104. First assume that, as shown in FIG. 7A, the subject vehicle 101 detects (recognizes) another vehicle 105 of similar size class to the subject vehicle 101 running in lane LN2 at higher speed than the subject vehicle 101. In response to this detection, the controller 40 uses the camera 31c to recognize vehicle size class of the other vehicle 105 and designates the other vehicle 105 as a target vehicle (S4). Therefore, as shown in FIG. 7B, the subject vehicle downshifts in preparation for an accelerating action (S7).

Thereafter, as shown in FIG. 7C, the subject vehicle 101 changes to lane LN2 to follow the other vehicle 105, namely, the target vehicle (S9). Since the transmission 2 has been downshifted (S7), acceleration response is high and the subject vehicle 101 can easily accelerate and follow the other vehicle 105 running at higher speed than the subject vehicle 101. Self-driving level is switched to level 3 at this time (S10). Driver forward surveillance obligation is therefore no longer necessary.

Next assume that at a time when, as shown for example in FIG. 8A, the subject vehicle 101 is running in self-driving level 2 while following behind a forward vehicle (e.g., a truck) 104 in lane LN2, the subject vehicle 101 detects (recognizes) another vehicle 105 running in lane LN1 at lower speed (vehicle speed difference of or greater than a predetermined value) than the subject vehicle 101. In response to this detection, the controller 40 designates the other vehicle 105 as a target vehicle (S4) and, as shown in FIG. 8B, downshifts the subject vehicle to invoke engine braking or regenerative force braking (S8). Thereafter, as shown in FIG. 8C, the subject vehicle 101 changes to lane LN1 to follow the other vehicle 105, namely, the target vehicle (S9). Since speed of the subject vehicle 101 is decelerated by engine braking or the like at this time, the subject vehicle 101 can easily decelerate and follow the other vehicle 105 running at lower speed than the subject vehicle 101.

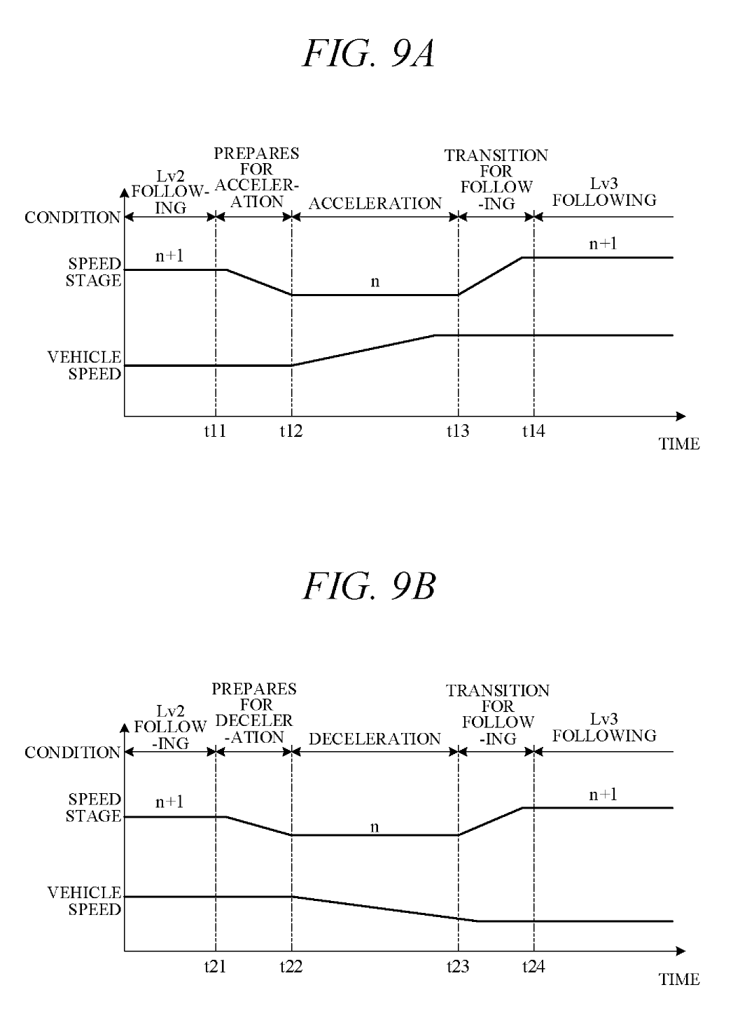

FIG. 9A is a time chart showing an example of speed stage and vehicle speed changes corresponding to the vehicle behavior illustrated in FIGS. 7A to 7C, and FIG. 9B is a time chart showing an example of speed stage and vehicle speed changes corresponding to the vehicle behavior illustrated in FIGS. 8A to 8C. These time charts begin from when the driving level instruction switch 33a instructs switching to level 3 (Lv3) during vehicle-following in level 2 (Lv2) behind another vehicle of different vehicle size class from the subject vehicle.

As indicated in FIG. 9A, when a vehicle of similar size class running at higher speed than the subject vehicle is designated as a target vehicle at time t11, the transmission 2 begins downshifting from n+1 stage to n stage (prepares for acceleration), and throttle opening angle is increased to start accelerating at time t12. When subject vehicle speed becomes equal to target vehicle speed at time t13, acceleration action is terminated and transition action for following the target vehicle (upshifting) is implemented to start vehicle-following in level 3 at time t14.

As indicated in FIG. 9B, when a vehicle of similar size class running at lower speed than the subject vehicle is designated as a target vehicle at time t21, the transmission 2 begins downshifting from n+1 stage to n stage (prepares for deceleration), and deceleration by engine braking or regenerative force braking is started at time t22. When subject vehicle speed becomes equal to target vehicle speed at time t23, deceleration action is terminated and transition action for following the target vehicle (upshifting) is implemented to start vehicle-following in level 3 at time t24.

The present embodiment can achieve advantages and effects such as the following:

(1) The travel control apparatus 110 of the self-driving vehicle 101 according to the present embodiment includes: the external sensor group 31 (called “vehicle detector”) including the LIDAR 31a, RADAR 31b and camera 31c for detecting other vehicles around the subject vehicle 101; the action plan generation unit 45 for generating an action plan so as to follow a target vehicle which is another vehicle detected by the vehicle detector and satisfying predetermined conditions; and the driving control unit 46 for in accordance with the action plan generated by the action plan generation unit 45 controlling the engine 1, transmission 2 and other members contributing to subject vehicle travel behavior (FIGS. 2 and 5). The action plan generation unit 45 includes the vehicle size class recognition unit 451 for recognizing vehicle size class of other vehicles detected by the vehicle detector, the vehicle size class determination unit 452 for determining whether the other vehicle satisfy a condition that degree of difference of vehicle size class of other vehicles recognized by the vehicle size class recognition unit 451 from vehicle size class of subject vehicle is equal to or less than a predetermined degree, more specifically, whether the other vehicle satisfy a condition that height difference and width difference are equal to or less than respective predetermined values, and the target vehicle designation unit 453 for designating as target vehicle the other vehicle determined to satisfy the condition by the vehicle size class determination unit 452.

This configuration ensures that the target vehicle followed by the subject vehicle is a vehicle of a size class similar to the subject vehicle that satisfies predetermined conditions, so that, for example, obstacles avoided by the target vehicle traveling ahead can similarly be avoided by the subject vehicle. Since this makes it possible to preclude situations such as of the subject vehicle being unable to avoid obstacles avoided by the forward vehicle, vehicle-following by autonomous driving can be continued safely in an appropriate manner. Moreover, a vehicle similar in size class to the subject vehicle is also generally similar in acceleration performance and deceleration performance, so that by ensuring that the subject vehicle follows a vehicle of similar size class, vehicle-following while maintaining inter-vehicle distance at desired distance can be easily achieved with high accuracy.

(2) The driving control unit 46 includes the driving level switching unit 463 (FIG. 5) that switches driving level during self-driving to a self-driving level of level 2 or below involving driver responsibility to monitor surroundings during vehicle traveling or to a self-driving level of level 3 or above not involving driver responsibility to monitor surroundings during vehicle traveling. When the driving level switching unit 463 is instructed by the driving level instruction switch 33a to switch from level 2 to level 3, for example, it switches driving level from level 2 to level 3 when the subject vehicle follows a target vehicle of similar size class designated by the target vehicle designation unit 453. Since self-driving level therefore switches to level 3 on condition of vehicle-following being performed with respect to another vehicle of similar size class, level 3 autonomous driving can be performed in a favorable manner.

(3) The travel control apparatus 110 (its driving control unit 46) includes the vehicle speed calculation unit 461 (FIG. 5) for calculating other vehicle speed. During running at self-driving level of level 2, the driving control unit 46 (its actuator control unit 462) responds to designation by the target vehicle designation unit 453 of another vehicle traveling in an adjacent lane as a target vehicle to be followed by controlling behavior of the transmission 2 in accordance with whether speed of the other vehicle is faster or slower than that of the subject vehicle. Specifically, the driving control unit 46 downshifts the transmission 2 when target vehicle speed is faster and either maintains or downshifts the speed stage of the transmission 2 when target vehicle speed is slower. This enables speed of the subject vehicle to be promptly changed to a desired speed matched to speed of the target vehicle and further enables the subject vehicle to easily change lanes to behind and follow the target vehicle.

(4) From among other vehicles whose degree of vehicle size class difference with respect to the subject vehicle is determined by the vehicle size class determination unit 452 to be equal to or less than a predetermined value, the target vehicle designation unit 453 designates as a target vehicle one thereof behind which the subject vehicle is determined to be capable of moving. This enables suitable designation of a target vehicle by ensuring that another vehicle, even if of similar size class to the subject vehicle, is not designated a target vehicle in cases such as when adequate space for lane changing is not available behind the other vehicle.

Various modifications of the aforesaid embodiment are possible. Some examples are explained in the following. In the aforesaid embodiment, other vehicles around the subject vehicle are detected by the LIDAR 31a, RADAR 31b, camera 31c and other members of the external sensor group 31, but a vehicle detector is not limited to this configuration. In the aforesaid embodiment, the driving control unit 46 controls the engine 1, transmission 2, braking apparatus, steering apparatus, and other members operating to travel the self-driving vehicle in accordance with the action plan generated by the action plan generation unit 45, but a driving control unit is not limited to this configuration. When an electric travel motor is used as a drive power source, the driving control unit can control the travel motor. Therefore, a driving part controlled by the driving control unit is not limited that set out in the foregoing.

Although in the aforesaid embodiment, the vehicle size class recognition unit 451 is adapted to recognize vehicle size class of other vehicles based on picture signals acquired by the camera 31c, a recognition unit is not limited to the aforesaid configuration and, for example, other vehicle size class data can instead be acquired by communication or the like. Although in the aforesaid embodiment, the vehicle size class recognition unit 451 recognizes other vehicle size class based on vehicle height and vehicle width, vehicle size class can instead be recognized from information other than vehicle height and vehicle width. In the aforesaid embodiment, the vehicle size class determination unit 452 is adapted to determine whether height difference and width difference between the subject vehicle and another vehicle are equal to or less than predetermined values, but, alternatively, vehicles can be classified by, for example, vehicle size class into multiple groups, such as two-wheeled vehicles, light four-wheeled vehicles, compact vehicles, medium-size vehicles, large-size vehicles and so on, and degree of difference between other vehicle size class and subject vehicle size class be determined to be equal to or less than a predetermined degree when the vehicles fall in the same class. Since in such case the vehicle size class determination unit 452 needs only to determine whether subject vehicle and other vehicle fall in the same group, a vehicle size class determination unit is not limited to the aforesaid configuration. In the aforesaid embodiment, the target vehicle designation unit 453 designates a target vehicle that, among other vehicles determined by the vehicle size class determination unit 452 to be of similar size class to the subject vehicle, the target vehicle designation unit 453 determines to be followable by the subject vehicle, but whether vehicle-following is possible can be determined by other than the target vehicle designation unit 453. Therefore, a designation unit can be of any configuration insofar as it designates the other vehicle determined by the vehicle size class determination unit to satisfy a condition that a degree of a difference of vehicle size class is equal to or less than a predetermined value, as the target vehicle.

In the aforesaid embodiment, the driving level switching unit 463 is adapted to respond to operation of the driving level instruction switch 33a by switching to a self-driving level of level 2 or below involving driver responsibility to monitor surroundings during vehicle traveling (first driving automation level) or to a self-driving level of level 3 or above not involving driver responsibility to monitor surroundings during vehicle traveling (second driving automation level). However, a driving level switching unit is not limited to the aforesaid configuration, and it is possible instead to adapt the driving level switching unit 463 to switch self-driving level automatically in accordance with vehicle traveling condition without relying on operation of the driving level instruction switch 33a. Although the aforesaid embodiment is explained regarding an example in which the driving level switching unit 463 switches self-driving level to level 3 during vehicle-following, the driving level switching unit can also switch self-driving level to level 3 or above in situations other than vehicle-following. Although in the aforesaid embodiment, the vehicle speed calculation unit 461 calculates target vehicle speed and the actuator control unit 462 determines whether vehicle speed of the self-driving vehicle is less than vehicle speed of the other vehicle, the vehicle speed determining unit is not limited to this configuration.

The present invention can also be used as a travel control method of a self-driving vehicle with a driving part for traveling.

The above embodiment can be combined as desired with one or more of the above modifications. The modifications can also be combined with one another.

According to the present invention, since a travel control apparatus is configured to follow a forward vehicle satisfying a condition that a degree of a difference of size class is equal to or less than a predetermined degree, a self-driving vehicle can avoid obstacles as the forward vehicle and perform a good forward traveling.

Above, while the present invention has been described with reference to the preferred embodiments thereof, it will be understood, by those skilled in the art, that various changes and modifications may be made thereto without departing from the scope of the appended claims.

What is claimed is:

1. A travel control apparatus of a self-driving vehicle with a driving part for traveling, comprising:
a vehicle detector configured to detect another vehicle around the self-driving vehicle; and
an electric control unit having a microprocessor and a memory, wherein
the microprocessor is configured to perform:
generating an action plan so as to follow the other vehicle detected by the vehicle detector as a target vehicle; and
controlling the driving part in accordance with the action plan generated in the generating so as to follow the target vehicle, and wherein
the microprocessor is configured to perform
the generating including:
recognizing a size class of the other vehicle detected by the vehicle detector;
determining whether the other vehicle satisfies a condition that a degree of a difference of the size class of the other vehicle recognized in the recognizing from a size class of the self-driving vehicle is equal to or less than a predetermined degree; and
designating the other vehicle determined to satisfy the condition in the determining as the target vehicle.

2. The apparatus according to claim 1, wherein
the microprocessor is further configured to perform switching a driving automation level to a first driving automation level involving a driver responsibility to monitor surroundings during traveling or a second driving automation level not involving the driver responsibility to monitor the surroundings during traveling, and
the switching including switching the driving automation level from the first driving automation level to the second driving automation level when the self-driving vehicle follows the target vehicle designated in the designating.

3. The apparatus according to claim 2, wherein
the microprocessor is further configured to perform determining whether a vehicle speed of the other vehicle detected by the vehicle detector is faster than a vehicle speed of the self-driving vehicle,
the driving part includes a drive power source and a transmission disposed in a power transmission path between the drive power source and drive wheels, and
the microprocessor is configured to perform
the controlling including controlling a speed ratio of the transmission in accordance with a result of the determining.

4. The apparatus according to claim 3, wherein
the transmission is a stepped transmission, and
the microprocessor is configured to perform
the controlling including downshifting the transmission when it is determined in the determining that the vehicle speed of the other vehicle is faster than the vehicle speed of the self-driving vehicle, and keeping a shift stage of the transmission or downshifting the transmission when it is determined in the determining that the vehicle speed of the other vehicle is equal to or slower than the vehicle speed of the self-driving vehicle.

5. The apparatus according to claim 1, wherein the microprocessor is configured to perform
when the self-driving vehicle is movable behind the other vehicle determined to satisfy the condition in the determining, the designating including designating the other vehicle as the target vehicle.

6. The apparatus according to claim 1, wherein the microprocessor is configured to perform
the recognizing including recognizing the size class of the other vehicle based on a height and width of the other vehicle detected by the vehicle detector, and
the degree of the difference is defined by differences between a height and width of the self-driving vehicle stored in the memory and the height and width of the other vehicle detected by the vehicle detector.

7. A travel control apparatus of a self-driving vehicle with a driving part for traveling, comprising:
a vehicle detector configured to detect another vehicle around the self-driving vehicle; and
an electric control unit having a microprocessor and a memory, wherein
the microprocessor is configured to function as:
an action plan generation unit configured to generate an action plan so as to follow the other vehicle detected by the vehicle detector as a target vehicle; and
a driving control unit configured to control the driving part in accordance with the action plan generated by the action plan generation unit so as to follow the target vehicle, and wherein
the action plan generation unit includes:
a recognition unit configured to recognize a size class of the other vehicle detected by the vehicle detector;
a vehicle size class determination unit configured to determine whether the other vehicle satisfies a condition that a degree of a difference of the size class of the other vehicle recognized by the recognition unit from a size class of the self-driving vehicle is equal to or less than a predetermined degree; and
a designation unit configured to designate the other vehicle determined to satisfy the condition by the vehicle size class determination unit as the target vehicle.

8. The apparatus according to claim 7, wherein
the microprocessor is further configured to function as a driving level switching unit configured to switch a driving automation level to a first driving automation level involving a driver responsibility to monitor surroundings during traveling or a second driving automation level not involving the driver responsibility to monitor the surroundings during traveling, and
the driving level switching unit is configured to switch the driving automation level from the first driving automation level to the second driving automation level when the self-driving vehicle follows the target vehicle designated by the designation unit.

9. The apparatus according to claim 8, wherein
the microprocessor is further configured to function as a vehicle speed determination unit configured to determine whether a vehicle speed of the other vehicle detected by the vehicle detector is faster than a vehicle speed of the self-driving vehicle,
the driving part includes a drive power source and a transmission disposed in a power transmission path between the drive power source and drive wheels, and
the driving control unit is configured to control a speed ratio of the transmission in accordance with a result of a determination by the vehicle speed determination unit.

10. The apparatus according to claim 9, wherein
the transmission is a stepped transmission, and
the driving control unit is configured to downshift the transmission when it is determined by the vehicle speed determination unit that the vehicle speed of the other vehicle is faster than the vehicle speed of the self-driving vehicle, and to keep a shift stage of the transmission or downshift the transmission when it is determined by the vehicle speed determination unit that the vehicle speed of the other vehicle is equal to or slower than the vehicle speed of the self-driving vehicle.

11. The apparatus according to claim 7, wherein when the self-driving vehicle is movable behind the other vehicle determined to satisfy the condition by the vehicle size class determination unit, the designation unit is configured to designate the other vehicle as the target vehicle.

12. The apparatus according to claim 7, wherein the recognition unit is configured to recognize the size class of the other vehicle based on a height and width of the other vehicle detected by the vehicle detector, and
the degree of the difference is defined by differences between a height and width of the self-driving vehicle stored in the memory and the height and width of the other vehicle detected by the vehicle detector.

13. A travel control method of a self-driving vehicle with a driving part for traveling, comprising:
detecting another vehicle around the self-driving vehicle;
generating an action plan so as to follow the other vehicle detected in the detecting as a target vehicle; and
controlling the driving part in accordance with the action plan generated in the generating so as to follow the target vehicle, wherein
the generating includes:
recognizing a size class of the other vehicle detected in the detecting;
determining whether the other vehicle satisfies a condition that a degree of a difference of the size class of the other vehicle recognized in the recognizing from a size class of the self-driving vehicle is equal to or less than a predetermined degree; and
designating the other vehicle determined to satisfy the condition in the determining as the target vehicle.
